(19) United States
(12) Patent Application Publication
(10) Pub. No.: US 2007/0186214 A1
(43) Pub. Date: Aug. 9, 2007

(54) Method of managing a task

(75) Inventor: Kevin Morgan, Sheffield (GB)

Correspondence Address: WILMER CUTLER PICKERING HALE AND DORR LLP, 60 STATE STREET, BOSTON, MA, 02109, US

(73) Assignee: ProMPTT Technologies Ltd., Broomhall (GB)

(21) Appl. No.: 11/642,052

(22) Filed: Dec. 19, 2006

Related U.S. Application Data
(60) Provisional application No. 60/753,526, filed on Dec. 23, 2005.

(51) Int. Cl. G06F 9/46

(52) U.S. Cl. 718/100

(57) ABSTRACT

Embodiments which provide a method of managing a task, the method involving updating a status of the task by determining a status of at least one lower level task associated with the task.

This application claims the benefit of U.S. Provisional Application No. 60/752,526, filed Dec. 23, 2005, the contents of which are incorporated herein by reference.

### TECHNICAL FIELD

Embodiments of this invention relate to a method of managing a task.

### BACKGROUND TO THE INVENTION

Organisational change, product delivery and/or service delivery is traditionally delivered via top-down command and control management methods and tools which allow a user to carry out management planning. Organisational change, product delivery and/or service delivery can be referred to as the delivery of a task. Typically, a task is split into one or m ore further tasks (referred to herein as sub-tasks), and each sub-task must be completed or cancelled for the originating task to be completed. Sub-tasks are normally handed over (assigned) to individuals or groups responsible for the completion of the sub-tasks by the owner of the task. These individuals or groups view the sub-tasks they have been assigned as tasks they own and are to complete. In order to complete an assigned task, the owner of the assigned task may split the task into one or more further sub-tasks which in turn may be handed over to other individuals or groups. As a result, the originating task will continue to be fragmented until a task is split into sub-tasks which include a physical activity, a decision or alternatively deliverables of some form. Such sub-tasks are not generally split any further. As the fragmentation continues, the original sub-task creator will begin to lose visibility of the status of his own sub-tasks and any further sub-tasks defined by the individuals or groups that own the sub-tasks.

Email is commonly used as a method of communication. Email is suited to the ad hoc nature of communications, decisions and queries. It is much less suited to be used as a tool for management planning of tasks and sub-tasks. This is because the command and control approach to management planning does not fit well with the ad-hoc nature of interactions (communications, decisions and queries) between the individuals or groups carrying out their day-to-day work.

Traditional management methods and tools rely upon task updates which are given when an update on progress has been requested or once an event has occurred. The updates are therefore nearly always out of date as they take place after activity has occurred, and in many cases are communicated by management layers who reinterpret the updates provided by the individuals who own the tasks. This can lead to problems for a task. For example, at a late stage in progress of a task, an update on a sub-task may be issued indicating that the sub-task is not complete in time. As a result, the task associated with the late sub-task may consequently be completed late, which has financial and customer service implications for an individual or group responsible for the task, or the task may fail completely, which may result in the money and effort already put into the task being wasted. Alternatively, an update itself may be misinterpreted or delivered late resulting in confusion about the sub-task status and as a result the status of the task itself.

It is an object of embodiments of the invention at least to mitigate at least some of the problems of the prior art.

### SUMMARY OF THE INVENTION

Aspects of embodiments of the invention are provided in the appended claims.

### BRIEF DESCRIPTION OF THE DRAWINGS

Embodiments of the invention will now be described by way of example only with reference to the accompanying drawings, in which:

FIG. 1 shows a hardware setup which can be used with embodiments of the invention;

FIG. 2 shows an example of a hierarchy of tasks;

FIG. 3 shows an example of an email form according to an embodiment of the invention;

FIG. 4 shows an example of an email containing an example of a task form according to an embodiment of the invention;

FIG. 5 shows an example of an email containing an example of a template form according to an embodiment of the invention;

FIG. 6 shows a plurality of associated tasks;

FIG. 7 shows a representation of a plurality of tasks;

FIG. 8 shows another representation of a plurality of tasks;

FIG. 9 shows another representation of a plurality of tasks;

FIG. 10 shows another representation of a plurality of tasks; and

FIG. 11 shows a plurality of representations of tasks.

### DETAILED DESCRIPTION OF EMBODIMENTS OF THE INVENTION

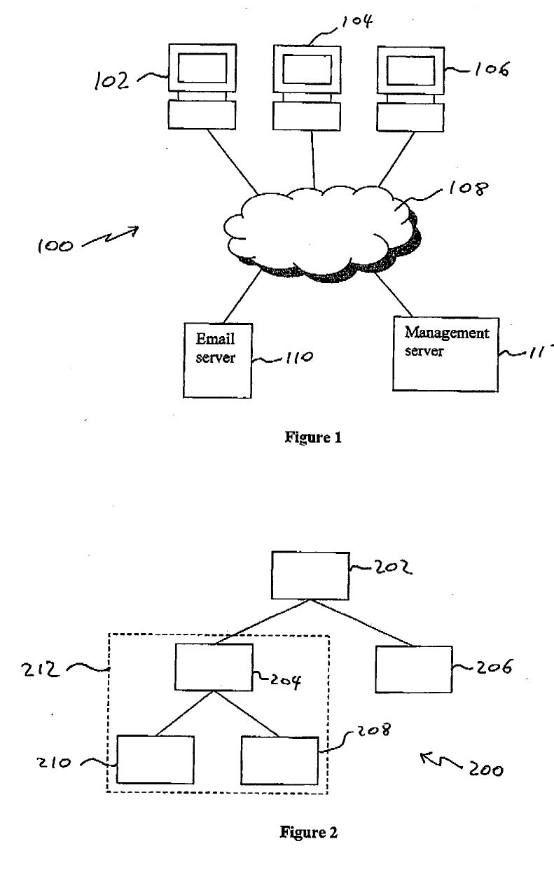

The setup 100 shown in FIG. 1 shows a plurality of computing devices 102, 104 and 106. The computing devices are connected to a network 108 such as, for example, an intranet, the internet, a wireless network or some other communications network. The network 108 may also comprise a combination of two or more communications networks, such as, for example, a combination of a wireless network and the internet.

An email server 110 is also connected to the network 108. The email server manages emails to be sent, for example, between the computing devices 102, 104 and 106. For example, a first computing device 102 may send an email to a second computing device 104. To do this, the first computing device 102 communicates the email to the email server 110. The email is then retained in the email server 110 until the second computing device 104 retrieves the email from the email server 110. The email may alternatively be sent by other means such as, for example, the first computing device 102 sending the email directly to the second computing device 104 via a direct connection or via the network 108.

A management server 112 is also connected to the network 108. The role of the management server will be described in more detail below.

The computing devices 102, 104 and 106 may each comprise one or more of a personal computer (PC), laptop, personal desktop assistant (PDA), mobile phone or any other suitable computing device.

FIG. 2 shows an example of a hierarchy 200 of tasks. The main task 200 to be completed is at the top of the hierarchy 200, and is referred to herein as the primary task 202. Two sub-tasks 204 and 206 are associated with the primary task 202. These sub-tasks must be completed in order for the primary task 202 to be completed. One of the sub-tasks 204 is associated with two further sub-tasks 208 and 210. These tasks 208 and 210 are sub-sub-tasks of the primary task 202, and must be completed in order for the sub-task 204 to be completed. The sub-tasks 204, 208 and 210 form another hierarchy 212 in which the sub-task 204 is the primary task.

A task (including a primary task), sub-task, sub-sub-task and so on will henceforth be referred to as a task and, unless the context otherwise requires, may refer to a task at any point in the task hierarchy.

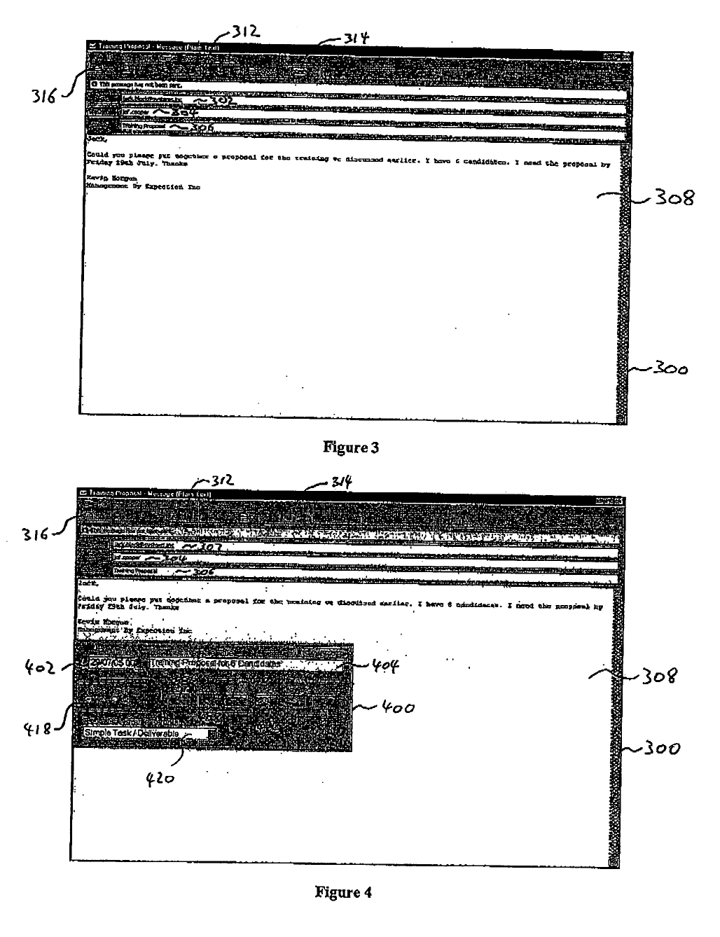

Embodiments of the present invention allow a user to create a task such as a task 202, 204, 206, 208 or 210 as shown in FIG. 2. FIG. 3 shows a screenshot of an example email form 300 which can be used to send an email to one or more recipients, and can also be used to create a task if desired. The email form 300 allows the user to specify one or more recipients in a “To” field 302, and optionally one or more further recipients in the “Cc” 304 and/or “Bcc” field (not shown). The form 300 also allows the user to enter a subject for the email in a subject field 306, and provides an area 308 for the message body. The message body may comprise text or graphics or a combination of text and graphics, or other information which the user wishes to send to the recipient. The email form 300 may in alternative embodiments contain more or fewer fields as appropriate.

The user creating the task may also choose to specify attachments which are to be sent with the email. Attachments are typically computer files. Attachments can be added using, for example, an attachment button 312 on the email form.

A task button 314 allows the user to create a task using the email 300. When the user selects the task button 314, for example by clicking the button 314 with a mouse pointer, a task form 400 appears in the message body 308 in the email form 300 as shown in FIG. 4. In alternative embodiments, the task form 400 may appear automatically in the email form 300.

The task button 314 may be used to remove the task form 400 if it is present in the email form 300, if the email user does not wish to create a task. Alternatively, the task form 400 may be hidden using the button 314 to allow the user to enter information in other fields of the email form 300 (including the message body 308) without changing the information in the task form 400. The email would still be used to create the task.

The task form 400 allows the user to enter details of the task to be created. In the example shown in FIG. 4, the task form 400 includes a due date field 402 for allowing the user to enter a due date for completion of the task being created. The task form 400 also includes a title field 404 for allowing the user to specify a title for the task being created.

The task form 400 contains six notification fields 406, 408, 410, 412, 414 and 416. In each of these notification fields, the user may enter a percentage value. This percentage value is a notification point. When the progress of the task being created should be that specified in a notification field then a status update request is initiated as explained in more detail below.

One of the fields 412 is a 100% notification point field. This field cannot be edited by the user. Notification fields 406, 408, 410, 414 and 416 can be activated or deactivated using a control 418 on the form 400, depending on whether or not the user creating the task wishes to specify notification points associated with the task. Notification points greater than 100% can be specified in notification fields 414 and 416, for instance where the task is expected to exceed the specified due date 402.

In alternative embodiments, there may be more or fewer than six notification fields on the task form 400. There may also be a variable number of notification fields, depending on the number of notification points desired by the user creating the task.

Once the user has entered all of the relevant details into the forms 300 and 400, the user may send the email using, for example, a send button 316 shown in FIGS. 3 and 4. The email is then sent to the recipient or recipients specified in the “To” and “Cc” fields 302 and 304 and “Bcc” field (not shown). The recipient specified in the “To” field becomes the user who is responsible for carrying out and completing the task (i.e. the user responsible for the task). Carrying out and completing the task may include creating sub-tasks for at least part of the task as appropriate. The task becomes a primary task for the recipient specified in the “To” field 302. If multiple recipients are specified in the “To” field 302, the user responsible for the task will be, for example, the first recipient specified.

As an example, the user creating the task may be using the computing device 102 as shown in FIG. 1. When the user sends the email containing the task details to the recipient, the email is communicated from the computing device 102 to the email server 110 via the network 108. The email server retains a copy of the email until the recipient checks his or her email, for example by using another computing device 104. The email server 110 then communicates the email to the computing device 104 via the network 108.

When the email server 110 receives the email containing the task details, the email server 110 also communicates the email to the management server 112. This is done as if an email address of the management server 112 is present in the “To”, “Cc” or “Bcc” field of the email containing the task details. Embodiments of the invention may include the email address of the management server 112 automatically in one of these fields.

The management server 112 stores the details of the task which has been created. The details may include any one or more of the details entered into the form 400, and/or any other details as appropriate. The email server may also store details of the user who created the task, and the user responsible for the task.

The management server 112 may also include capabilities to operate as an email server, in order to accept incoming emails from the email server 110. Alternatively, the management server 112 may use the email server 110 as its email server and the management server 112 may then retrieve emails from the email server in a manner similar to the retrieval of email by the email recipient, or the management server 112 may retrieve emails directly from the underlying data held in the email server 110.

The management server 112 may instead use a further email server (not shown) to store email in a manner similar to that carried out by the email server 110. In this case, the email may be communicated from the email server 110 to the management server's email server, or may alternatively be communicated directly from the computing device 102 to the management server's email server, or may be communicated to the management server's email server by other means as appropriate. The management server 112 may then retrieve emails from its email server as appropriate, for example periodically. The email server 110 may communicate with any number of email servers within the network 108. The management server 112 may communicate with one or more of these servers.

The task form 400 in the email form 300 shown in FIG. 4 includes a template field 420. Using the template field 420, the user creating the task can choose a template which can be used to enter further details relating to the task being created.

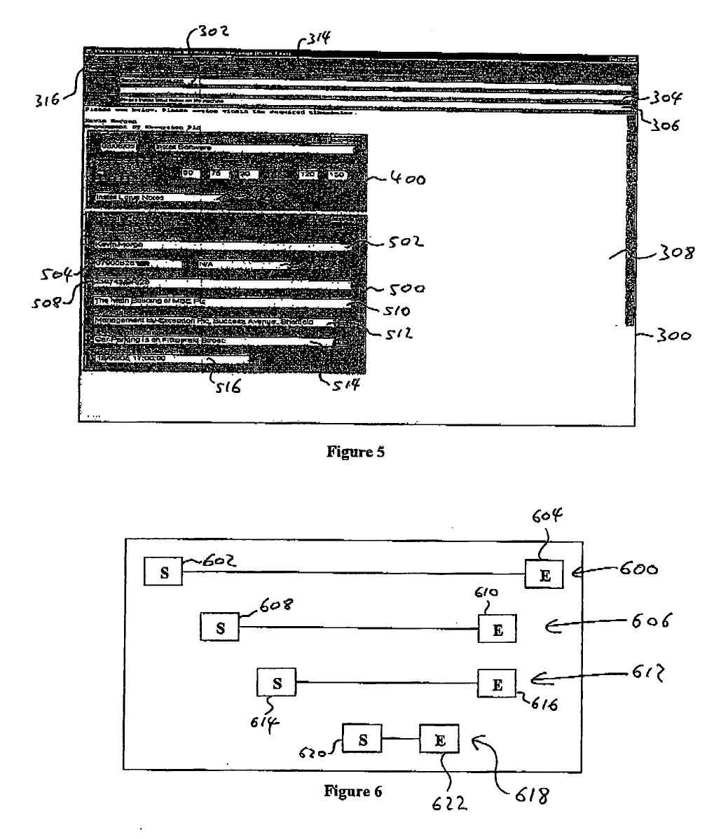

FIG. 5 shows an example of an email form where a template has been selected using the template field 420. When a template is selected, a template form 500 appears in the email form 300. The template form 500 contains one or more fields which can be used to specify further details relating to the task being created. The example template form 500 shown in FIG. 5, which is a template relating to a task which is installation of software on a PC or laptop, allows the user creating the task to specify a PC or laptop owner name 502, mobile 504 and land line 506 telephone numbers, a PC or laptop asset number 508, a location 510, an address 512 and special instructions 514. The chosen template may include fields to allow the user to enter any relevant information relating to the task being created. The completion date and time 516 will be populated by the management server 112 in response to notification point requests for updates and/or, ad-hoc updates from the user responsible for completing the task as described below.

The information entered in the template form 500 is also sent with the email 300 when the email is sent using, for example, the send button 316.

The user responsible for the task, when he or she receives the email containing details of the task, has the option of accepting the task or rejecting it. This can be implemented, for example, in one or more of a number of ways:

1) The email containing the task details may contain interactive portions which allow a user responsible for the task to select one of at least an acceptance option and a rejection option. The interactive portions may then inform the user who created the task and/or the management server 112 using one or more emails as appropriate. However, the email containing the task details and acceptance options may be considered by security and/or anti-virus software to contain an embedded application or other security risk and could be blocked by the software or contain reduced functionality.

2) The user responsible for the task may select a “reply to all” option on the email containing the task details. This generates a reply email where the “To”, “Cc” and “Bcc” fields contain the email address of the user who created the task and the email addresses (if any) of recipients of the original email containing the task details. One of these email addresses is that of the management server 112. The email address of the user responsible for the task may be omitted. The reply email contains forms (not shown) which allow the user responsible for the task to specify whether the task is accepted or rejected. The user responsible for the task must ensure that the “reply to all” option is used, rather than a “reply” option which will send the reply email to the task creator only. In this case, the management server 112 may not be informed of the choice of the user responsible for the task. This may be solved in alternative embodiments of the invention by, for example, disabling the “reply” option, and/or by automatically generating an email to the management server 112 when replying to the email creating the task, and/or by the task creator's computing device sending an email to the management server 112 informing the server of the choice of the user responsible for the task when the task creator receives the reply email containing an indication of the choice.

3) Embodiments of the present invention could be implemented which ensure that the email containing the indication of the acceptance or rejection by the user responsible for the task is sent to the management server 112 and not to the user who created the task. The user who created the task may then interrogate the management server 112 at a later date to determine the choice of the user responsible for the task, and/or the management server may send an appropriate email to the user who created the task.

In certain embodiments, if the user responsible for the task rejects the task, then he or she is no longer responsible for the task. In certain embodiments, the user creating the task may be able to specify that the user responsible for the task cannot reject the task.

There are also other possibilities which depend on, amongst others, the implementation of embodiments of the present invention and/or the type of computing device or devices used by each user creating and/or responsible for tasks.

If the user responsible for the task accepts the task assigned to him or her, the user becomes the owner of the task and he or she can then complete the task as appropriate, which may include creating or determining one or more new sub-tasks associated with at least part of the task. The new sub-tasks may be assigned to users which include, for example, new users, users responsible for other tasks, and the user creating the sub-tasks. The management server 112 maintains details of the tasks and any associated tasks as appropriate. The management server 112 may determine details of and/or relationships between tasks as appropriate, for example by receiving emails containing task details. In this way, the management server may hold details of an entire task hierarchy such as that shown in FIG. 2.

In certain embodiments of the invention, each task has or is associated with a task status which may contain information about the status of the task, for example if the task is complete. The task status may also contain a progress level of the task, for example 50% complete.

The notification points that are defined in the task form 400 are used in conjunction with the due date 402 and the task completion profile (described in more detail below) by the management server 112 to determine when a communication (a status update request) should be sent to the user responsible for the task requesting an update on the task status. A response period within which the user responsible for the task must provide the update is specified on the task form 400 in a response period field (not shown) by the user creating the task. The management server 112 will then issue a request to the user responsible for the task for an update on the status of the task based upon the notification points associated with the task. The user responsible for the task can receive the status update request via any communication method such as, for example, those previously outlined. The user responsible for the task can similarly respond to the management server using any communication method such as, for example, those previously outlined with the update on the task status. For example, a task may be created and/or accepted on the 1^{st} October with a due date of the 10^{th} October, and two notification points are defined as 50% and 100%. There is therefore a 10-day completion period for the task. The task completion profile assigned to the task in this example is a linear profile which means that progress of the task should be equal to the proportion of time elapsed in the 10 day completion period. The response period is set by the user who created the task and is set, for example, to half a day. As a consequence, on the 5^{th} October (i.e. 50% through the completion period) the management server 112 will issue a status update request to the user responsible for the task corresponding to the 50% notification point. The user responsible for the task must then confirm that the progress of the task is at least 50% complete, or that the task progress has not yet reached 50% complete. Alternatively, the user responsible for the task may not respond to the notification point update request within the half day response period. The task status held by the management server 112 will be updated accordingly. For example, if the user responsible for the task indicates that the task is at least 50% complete, then the task status will be updated to show that the task is proceeding according to plan. If the user responsible for the task indicates that the task is not 50% complete, the status of the task will be updated to show that the task is not proceeding according to plan. If the user responsible for the task does not respond in time, the status may be updated to be stalled, delayed or any other status as appropriate. If the user submits the response late (outside of the response period), then the management server 112 may belatedly update the task status.

The management server may also update the task status of associated higher level tasks (i.e. tasks which have the updated task as a sub-task, sub-sub-task and so on). The management server 112 may issue an email or other form of communication to the user who created the task to inform them of the status at the planned 50% completion point.

Embodiments of the invention may allow the creator of a task to specify a different task completion profile. For example, the creator of a task may be able to specify that the task should quickly progress to 50% complete and more slowly progress to 100% complete. The status update requests (if any) will be issued at appropriate points where the task is expected to have reached a certain progress level. Other task completion profiles are acceptable.

Embodiments of the invention may include the ability to apply different rules to the status update request calculations, for example, taking into account working days, national holidays and/or any other considerations that may affect the handling of status update requests.

A user responsible for a task may use embodiments of the invention to specify that a task is partially complete, or that its status has changed, without having received a status update request. The user responsible for the task may do this by creating an email and using a form in the email to specify progress of the task in terms of a percentage complete, for example a half-completed task is 50% complete. The form may be a template form 500, or relevant fields may be included in the task form 400. Alternatively a further form (not shown) may be invoked using either a control or field on the task form 400 or using another button (not shown) on the email form 300.

Still alternatively, the email sent to the user responsible for the task containing the task details may include a feature which allows the user responsible for the task to specify and/or change the status of the task assigned to him. For example, the email may include forms which allow the user responsible for the task to specify the status of the task, which may include a progress level of the task. An email may be automatically created which informs the user who created the task and/or the management server 112 of the new status of the task. Alternatively, the user responsible for the task may be able to reply to the email containing details of the task (using, for example, a reply button (not shown) on the email when viewed by the user responsible for the task) and use a form in the reply email to specify a progress of the task. The user responsible for the task is therefore able to control when the status of a task changes such that the status reflects that the task has progressed a certain amount (for example, a certain percentage), or that the task is incomplete (0%), partially complete (1-99%) or complete (100%), or its status has otherwise changed.

Additionally or alternatively, the management server 112 may control the status of a task by monitoring the progress and/or status of any associated lower level tasks (sub-tasks, sub-sub-tasks and so on). For example, the management server 112 may divide the number of completed associated sub-tasks by the total number of associated sub-tasks to obtain a fraction of the associated sub-tasks which are complete. This can be converted into a percentage value as appropriate. Additionally or alternatively, the management server may take into account associated sub-tasks which are partially complete. For example, a task which has two associated sub-tasks, one of which is complete and the other is 50% complete, may be determined by the management server as being 75% complete. Additionally or alternatively, the management server 112 may use methods of calculating the progress and/or status of a task based upon the task completion profile of the task, taking into account variable rates of progress depending upon the point at which the task is in its current life cycle. For example, within a primary task, there will be considerable effort at the beginning and end of the task required to complete the task. As a consequence, a ‘U’ shaped curve will reflect the expected rate of task progress throughout the life of the task. The task completion profile may take the form of the expected rate of task progress, the expected progress level throughout the life of the task (i.e. the integration of the expected rate of progress), or any other appropriate form. The management server 112 will use the relevant task completion profiles in its calculations as to the progress of a task at a particular point, and when to issue the notification point update requests to the users responsible for the tasks.

Embodiments of the invention may include the ability to inherit task completion profiles within the hierarchy of tasks, for example, a sub-task associated with a task inherits the task completion profile of the associated task. In certain embodiments, the inherited profile may be a default profile unless the user creating the sub-task specifies an alternative profile.

The management server 112 may determine the status of a particular task be receiving one or more emails from one or more users responsible for associated tasks containing updates of the status of one or more associated tasks. Additionally or alternatively, the task server 112 may request the status of a task by sending an email or other form of communication to the user responsible for the task requesting a status update.

FIG. 6 shows an example of a plurality of representations of tasks in an example hierarchy. The representations are timelines. A representation of a primary task 600 has a start point 602 and an end point 604 in time. A representation of a sub-task 606 of the primary task 600 also has a start point 608 and an end point 610. The sub-task 606 must be completed in order for the primary task 600 to be completed. It follows that the start point 608 of the sub-task 606 cannot be before the start point 602 of the primary task 600, or the end point 610 of the sub-task cannot be after the end point 604 of the primary task 600. There are exceptions to this rule, such as, for example, if the primary task 600 can be completed before the sub-task 606 is fully completed, if the sub-task 606 can be started before the primary task 600 is started, or if the sub-task completion point 610 of the sub-task 606 is not completed at or before the expected end point 604 of the primary task 600. In the latter case, the end point 604 of the primary task 600 may need to be moved (for example, my moving the due date of the task) to encompass the end point 610 of the overrunning sub-task 606. The initially defined end point 604 of task 600 may be recorded for comparative purposes, for example to compare the originally specified due date with the actual completion date.

The timelines are arranged in parallel and as a vertical stack of timelines.

The sub-task 606 itself has an associated sub-task 612 with a start point 614 and end point 616. The sub-task 612 is a sub-sub-task of the primary task 600. The task 612 also has an associated sub-task 618 with a start point 620 and an end point 622.

In at least some situations, the tasks must be completed in the following order: 618, 612, 606 then 600. In other words, the tasks must be completed in increasing position in the hierarchy (if the primary task 600 is considered to be at the highest point in the hierarchy). If any of the tasks becomes stalled, the primary task 600 will remain incomplete or partially complete (and may be considered to be stalled) until the stalled task is resumed or dealt with otherwise.

In certain prior art systems, the only user who is aware of the progress and/or status of a task is the user responsible for the task. If a user wishes to know the progress and/or status of a task for which that user is not responsible, that user must generate an enquiry communication to the user responsible for the task to discover the progress and/or status of the task. This may require further communications to users responsible for associated lower level tasks. Any communication may result in one or more reply communications and may also go unanswered, resulting in further enquiry communications and/or delays in updating the status of higher level tasks.

FIG. 7 shows an example of a representation 700 of the primary task 600 and the associated sub-tasks 606, 612 and 618. The representation includes each of the timelines of FIG. 6 superimposed on each other, and includes the start points 602, 608, 614 and 620 and the end points 604 and 622. In FIG. 6, the end points 610 and 616 are shown to be at substantially the same point in time, and are represented by the point 702 in FIG. 7. The representation shown in FIG. 7 is more compact, and can more easily be viewed using, for example, a display device of a computing device. However, the representation 700 is less clear than that shown in FIG. 6 as the timelines and start and end points are close together and may overlap. The representation 700 is linearly arranged between the start point 602 and the end point 604.

In FIG. 6 and 7, the timelines may additionally or alternatively represent one or more other attributes of the tasks such as, for example, a progress level where a start point represents 0% complete and an end point represents the planned or actual 100% completion point.

FIG. 8 shows an example of a representation 800 of the primary task 600 of FIG. 6. A first symbol 802 represents the primary task 600. A second symbol 804 represents the task 606. A third symbol 806 represents the task 612. A fourth symbol 808 represents the task 618. The symbols are linearly arranged in the order in which they must be completed for the primary task 600 to be completed. An arrow 810 represents the flow of tasks—i.e. the tasks must generally be completed in the order in which the associated symbols are encountered if the arrow is followed from start to end. The end of the arrow is represented by an arrow head. This does not preclude tasks or sub-tasks being completed out of sequence.

FIG. 9 shows an example of an alternative representation 900 containing the symbols from the representation 800 of FIG. 8. In the representation 900, the symbols are not arranged linearly but are arranged generally in an inverted U-shape. The arrow 902 representing the flow of tasks assumes generally an inverted U-shape as appropriate.

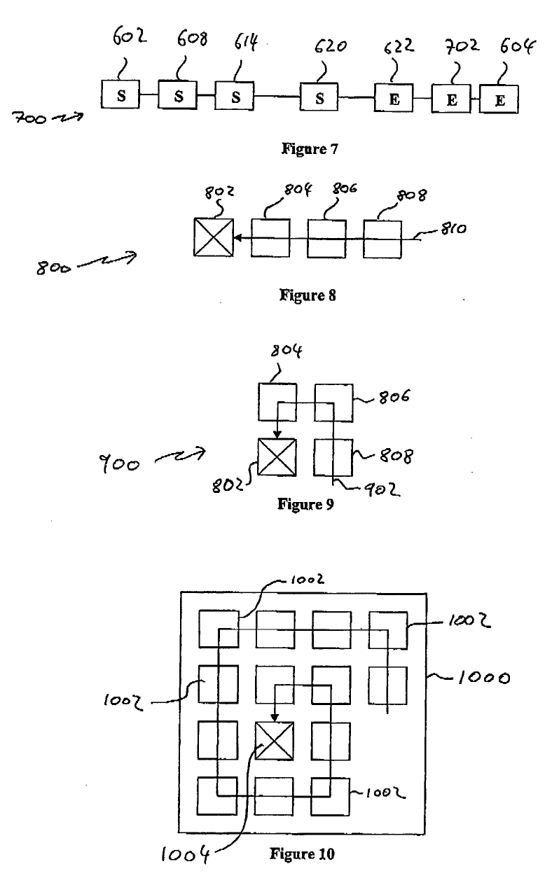

For a primary task which is associated with a large number of lower level tasks, a representation 1000 of the primary task may include symbols 1002 representing the associated lower level tasks arranged in a square spiral as shown in FIG. 10. A central symbol 1004 represents the primary task itself. This arrangement of the symbols can be more convenient than other arrangements where the tasks are arranged in a linear fashion, for example as shown in FIGS. 6, 7 and 8. For example, if the symbols are arranged as shown in FIG. 8, the representation of the primary task showing the associated lower level tasks would be extremely long and may not be displayable in its entirety and/or clearly on a display device of a computing device. The representation 1000 shown in FIG. 10 is a more compact way of representing the task and can therefore more easily be displayed on a display device. A display device may comprise, for example, a computer screen of a PC, a display of a mobile telephone or PDA, or other suitable display device.

In the representation 1000 of a primary task, a symbol is generally adjacent to at least three other symbols, ensuring that the representation is more compact and/or clearer than, for example, those shown in FIGS. 6, 7 and 8. Alternatively, any non-linear arrangement of the symbols may also give a more compact and/or clearer representation. For example, a non-linear arrangement of the symbols may arrange the symbols to fit into a rectangular window which may be more clearly displayed and/or displayed fully on a rectangular display device when compared to a linear arrangement.

It is noted that the primary task being represented may itself be a sub-task of an associated higher level task. The task being represented may therefore be a primary task from the point of view of the user responsible for the task and/or the user viewing the representation of the task.

In other situations, a task may have, for example, two or more associated sub-tasks (the sub-tasks being at the same level in the task hierarchy). This may be represented in the representations of FIGS. 8, 9 and 10 by providing two or more symbols as appropriate positioned before a symbol relating to the task along the arrow representing the flow of tasks, around the symbol relating to the task, or some other form of representation (not shown). The symbols representing the sub-tasks may be consecutive, or they may not be consecutive if, for example, one of the sub-tasks is associated with its own sub-task or sub-tasks. Embodiments of the invention may present alternative symbols to indicate, for example, that a sub-task of the primary task being represented has its own associated sub-task or sub-tasks.

In certain embodiments, the representation 1000 may display symbols representing all lower level tasks associated with the primary task being represented, i.e. all sub-tasks, sub-sub-tasks and so on. In other embodiments, the user viewing the representation 1000 may be able to select the number of levels to be displayed, or the number of levels to be displayed may be specified some other way. For example, the user may be able to choose to view all lower level tasks associated with the primary task being represented, only one level lower in the hierarchy (i.e. only sub-tasks), two levels lower (i.e. sub-tasks and sub-sub-tasks), and so on.

The ability to specify a selected number of levels in the hierarchy for display ensures that the displayed representation is clearer and/or more compact than, for example, those shown in FIGS. 6, 7 and 8. Furthermore, information in which the task viewer is not interested (for example, associated tasks many levels lower in the task hierarchy) can be hidden, as the associated symbols will not be displayed, so the representation is also more relevant to the viewing user's requirements and/or point of view.

In certain embodiments, the colour of a symbol (such as a symbol 1002 or 1004 as shown in FIG. 10) provides information on the status and/or progress level of the task which the symbol represents. There are many ways that this can be implemented. However, an example of the colour of a symbol is given as follows:

1) If a task is complete, or partially complete but the completion deadline has not passed, then the colour of the associated symbol may be green indicating that the task is proceeding as planned.

2) If a task is stalled, or incomplete/partially complete but the completion deadline has passed, then the colour of the associated symbol may be red to indicate that the task is not proceeding as planned.

3) If a task is incomplete and the completion deadline has not yet passed, the symbol may be clear indicating that the task has not yet begun but is not stalled.

Other colours and situations are envisaged. For example, embodiments of the invention may allow a user creating a task to enter both notification points and dates and times associated with the notification points. In this case, the symbol representing a task may, for example, turn to red if the progress of the task has not reached the required amount of progress by the date and time associated with a notification point. Embodiments of the invention may present symbols in a variety of shades of a colour to indicate, for example, a completion level or proximity to a deadline.

In certain embodiments, the status and/or progress of a primary task may take the “worst case” colour of any associated sub-tasks. For example, if a primary task has one or more sub-tasks which are red, then the primary task itself may be represented using a red colour. If the sub-tasks are all clear or green, then the primary task itself may be represented using a green colour or a clear symbol.

The central symbol (for example, symbol 1004 shown in FIG. 10) represents the primary task and its colour may represent the task's status and/or progress level. However, a user may wish to quickly determine the status and/or progress of the primary task without wishing to determine the status of any associated sub-tasks. The representation 1000 as shown in FIG. 10 may therefore, in certain embodiments of the invention, have a background 1006 which is a colour representing the status and/or progress of the primary task. In this case, the central symbol 1004 may reflect the colour of the background 1006, may be a predetermined colour, or may be a colour which conveys other information.

In certain embodiments of the present invention, when a user first displays the representation 1000, the computing device the user is using communicates with the management server 112 to determine the status and/or progress of the task being represented and any associated sub-tasks, sub-sub-tasks and so on being displayed as a symbol in the representation 1000. Determining the status of a sub-task may require the management server to determine the status of any associated lower level tasks. The management server 112 may determine the status of a task by interrogating a database (internal to the server 112, or located elsewhere but in communication with the server at least some of the time). In this case, a user responsible for a task or a computing device used by the user updates the database when the status of the task changes (for example, from partially complete to complete), or when the progress level of the task changes. Additionally (for example if the status of a task is unavailable from the database) or alternatively, the management server may determine the status of a task by communicating with the user responsible for the task, and/or communicating with the computing device or devices used by the user. Additionally or alternatively, the management server may keep the user monitoring/viewing the task updated, for example by sending update emails to the user. Embodiments of the invention will receive the emails and/or other forms of communication and update the task representation. This happens, for example, continually, when the user's computing device is active, periodically or when the user views the task representation.

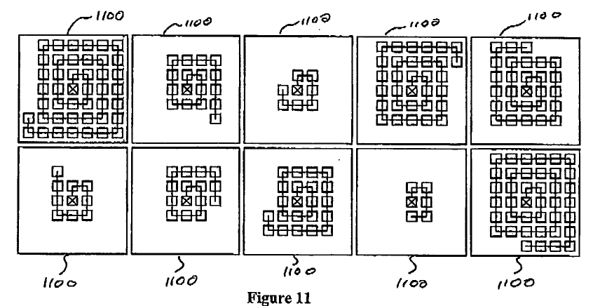

FIG. 11 shows a plurality of representations 1100 of tasks where each representation is of the form of the representation 1000 shown in FIG. 10. The representations 1100 are arranged in a 5×2 grid. It can be seen that it is possible to arrange a plurality of representations of tasks into a relatively small space, such that the progress and/or status of each representation can be quickly determined at a glance. The status/progress of a task and/or any associated sub-tasks, sub-sub-tasks and so on can be determined more easily than with representations such as those shown in FIGS. 6 and 7. There is no need to scroll the display to view any part of each representation. The size of the symbols representing sub-tasks and/or the area taken up by each representation 1100 can be adjusted depending on the number of tasks being represented and the number of associated symbols representing sub-tasks.

The representations 1100 shown in FIG. 11 are tasks selected by a user viewing the tasks. The selected tasks may be, for example, primary tasks which are under the user's control or responsibility. Alternatively, the tasks may be, for example, sub-tasks of a task (i.e. the representations 1100 shown in FIG. 11 are sub-tasks at the same level in a single task hierarchy). Alternatively, the tasks may be, for example, tasks selected by the user which are not necessarily related to each other.

In certain embodiments of the present invention, the representations of tasks shown in FIGS. 6, 7, 8, 9, 10 and/or 11 are interactive. A user may select one of the sub-tasks (or sub-sub-tasks, and so on) shown in a representation, for example representation 1000 or 1100, in order to “zoom” in on the selected task. A selected task is then displayed as, for example, a single representation 1000 such as that shown in FIG. 10, or as a plurality of representations 1100 of sub-tasks as shown in FIG. 11.

In certain embodiments of the present invention, the representation of tasks shown in FIGS. 10 and/or 6 is interactive. A user may select the primary task 1004 or one of the associated lower level tasks shown in representation 1000 in order to display the task hierarchy in an alternative way, for example, using the representation 624, 700 or 800 as shown in FIG. 6, 7 or 8 respectively. Alternatively, a task may be represented using a representation similar or identical to a form 300, 400 and/or 500 shown in FIGS. 3, 4 and 5.

In alternative embodiments of the invention, the email server 110 and management server 112 shown in FIG. 1 are combined to form a single server (not shown). This conveniently integrates two functions into a single server and may eliminate the need for communication between the email server 110 and management server 112 using the network 108.

In alternative embodiments of the invention, the management server 112 is not required. Instead, embodiments of the invention can use email communications to keep the status and/or progress of a task updated from the point of view of a user monitoring the task. The recipient of an email containing task details can use features embedded in the email and/or software according to embodiments of the invention to generate the appropriate response emails, for example acceptance/rejection emails and progress/status update emails, to be sent to the appropriate recipient, for example a user monitoring the task and/or a user who created the task. The emails could additionally or alternatively be generated automatically. In this way, the status and/or progress of a task can be monitored and the information will be up-to-date. The need for follow-up emails and effort to determine task status and/or progress manually is reduced or eliminated.

Embodiments of the present invention can be used to assign tasks to individuals or groups which do not use software according to embodiments of the present invention which generate forms as shown in FIGS. 3, 4 and 5 and as described above. If suitable information and instructions are included in an email which contains details of a task assigned to an individual or group, the individual or group may not need the software according to embodiments of the present invention. However, any tasks assigned will not be managed according to embodiments of the present invention unless a user specifically informs one or more elements of embodiments of the present invention of information relating to one or more tasks outside the control of embodiments of the present invention.

Embodiments of the present invention allow a user to monitor a task and view information which is up-to-date. This can allow action to be taken in respect of certain tasks such as, for example, stalled tasks so that the progress, status and/or fate of a task at a higher level in the task hierarchy is unaffected or affected to a lesser degree.

A server as referred to above can comprise a single computing device or a plurality of computing devices as appropriate. An example of a plurality of computing devices which can be used as a single server is a load-balancing cluster.

Any email or communication referred to above may instead be replaced by one or more of the following communications: email, SMS message, MMS message, other electronic communication and other wireless communication. A communication may also, if appropriate, include telephone or video conversations, instant messaging services and the like. Any communication from one entity to another (such as, for example, from one user to another, between a server and a user, or between servers) may also be copied to one or more other entities as appropriate and/or may be sent via one or more other entities. For example, a communication from one computing device to another computing device may be communicated via an email server and may be held for a period of time by the email server before being propogated to the recipient.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A method of managing a task, said method comprising updating a status of the task by determining a status of at least one lower level task associated with the task.

2. The method of claim 1, further comprising receiving the status of an associated lower level task when the status of the associated lower level task changes.

3. The method of claim 1, comprising requesting the status of an associated lower level task and receiving the status of the associated lower level task.

4. The method of claim 1, wherein the status of the task is:
a) incomplete if the status of all associated lower level tasks is incomplete;
b) partially complete if the status of any of the associated lower level tasks is partially complete;
c) complete if the status of all of the associated lower level tasks is complete; and
d) stalled if the status of any of the associated lower level tasks is stalled.

5. The method of claim 1, further comprising storing details associated with at least one of the task and at least one of the associated lower level tasks on a management server.

6. The method of claim 5, further comprising storing a status of the task or associated lower level tasks on the management server.

7. The method of claim 1, further comprising sending details of at least one of the associated lower level tasks to a management server, and storing at least one of the details and the status of the associated lower level tasks on the management server.

8. The method of claim 1, further comprising specifying notification points associated with at least one of the associated lower level tasks.

9. The method of claim 8, further comprising sending a status update request to at least one of a user responsible for one of the associated lower level tasks and a management server when a progress of the associated lower level task should have reached one of the notification points associated with the associated lower level task.

10. The method of claim 8, further comprising sending a notification to a user when a progress of a lower level task reaches one of the notification points associated with the lower level task.

11. A task management system programmed to:
determine a plurality of notification points associated with at least one lower level task associated with a task;
send status update requests to one or more users responsible for the associated lower level tasks; and
receive at least one communication from one or more users responsible for the associated lower level tasks indicating a status of an associated lower level task in response to the status update request.

12. The system of claim 11, further programmed to receive a status update from a user responsible for an associated lower level task when the user wishes to indicate the status of the associated lower level task.

13. A data processing system programmed to:
receive details of a task;
receive details of at least one lower level task associated with the task; and
update a task status of the task by obtaining a task status of the at least one associated lower level task.

14. The system of claim 13, further programmed to update the task status by requesting at least one task status update from at least one user responsible for an associated lower level task, receiving at least one task status update from the at least one user responsible for the associated lower level task, and updating the task status in response to the at least one task status update.

15. The system of claim 13, further programmed to send the updated task status to at least one of a user responsible for the task and at least one user responsible for an associated lower level task.

16. The system of claim 13, further programmed to update the task status by receiving at least one task status update from at least one user responsible for an associated lower level task, and updating the task status in response to the at least one task status update.

17. The system of claim 13, further programmed to set the task status to:
a) incomplete if the status of all associated lower level tasks is incomplete;
b) partially complete if the status of any of the associated lower level tasks is partially complete;
c) complete if the status of all of the associated lower level tasks is complete; and
d) stalled if the status of any of the associated lower level tasks is stalled.

18. The system of claim 13, wherein the details of an associated lower level task include an indication of a plurality of notification points associated with the associated lower level task.

19. The system of claim 18, further programmed to send a communication to at least one of a user responsible for the task and at least one user responsible for an associated lower level task when the status of an associated lower level task should have reached one of the notification points associated with the associated lower level task.

20. A method of managing a task, said method comprising:
determining at least one of notification point associated with at least one lower level task associated with a task; and
requesting a status update for one of the associated lower level tasks; and
receiving a communication indicating a status of one of the associated lower level tasks in response to the status update request.

21. The method of claim 20, further comprising receiving a communication indicating a status of an associated lower level task from a user responsible for the associated lower level task when the user wishes to provide details of the status of the associated lower level task.

22. The method of claim 20, wherein requesting a status update comprises sending a status update request to a user responsible for the associated lower level task.

23. A method of displaying a plurality of representations of tasks, said method comprising displaying the representations in a non-linear arrangement.

24. The method of claim 23, wherein representations of two consecutive tasks are displayed adjacent to each other.

25. The method of claim 23, wherein the representation of a task includes an indication of the status of the task.

26. The method of claim 25, wherein the indication of the status of the task includes the colour of the representation of the task.

27. The method of claim 26, wherein the colour of the representation of the task comprises at least one of:
a) a first colour for an incomplete task;
b) a second colour for a partially complete task;
c) a third colour for a completed task; and
d) a fourth colour for a stalled task.

28. The method of claim 23, wherein at least one task comprises one or more associated lower level tasks.

29. A method as claimed in claim 28, wherein a user may interact with the at least one task to display representations of the associated lower level tasks.

30. The method of claim 29, further comprising displaying the representations of the associated lower level tasks in a non-linear arrangement.

31. The method of claim 23, wherein the representations are displayed in a predetermined pattern.

32. The method of claim 31, wherein the predetermined pattern is a spiral.

33. A computer program stored on computer readable medium, said computer program for causing a computer system to perform the functions of updating a status of a task by determining a status of at least one lower level task associated with the task.

34. A computer program stored on computer readable medium, said computer program for causing a computer system to perform the functions of:
determining at least one of notification point associated with at least one lower level task associated with a task; and
requesting a status update for one of the associated lower level tasks; and
receiving a communication indicating a status of one of the associated lower level tasks in response to the status update request.

35. A computer program stored on computer readable medium, said computer program for displaying a plurality of representations of tasks, said computer program for causing a computer system to perform the functions of displaying the representations in a non-linear arrangement.
